(19) United States
(12) Patent Application Publication
(10) Pub. No.: US 2010/0163391 A1
(43) Pub. Date: Jul. 1, 2010

(54) IDENTIFICATION SWITCH ASSEMBLY

(76) Inventor: Vincent Kuo, Taipei (TW)

Correspondence Address: Yen Jung Sung, 21-80 38 St, #C8, Astoria, NY, 11105, US

(21) Appl. No.: 12/411,394

(22) Filed: Mar. 26, 2009

(30) Foreign Application Priority Data
Dec. 31, 2008 (TW) 097151925

(51) Int. Cl. H01H 3/20; H01H 13/14; H01H 13/52

(52) U.S. Cl. 200/52 R; 200/61.59

(57) ABSTRACT

The identification switch assembly according to the present invention has an identification switch and at least one driving card for driving the switch. The identification switch has a plurality of conductive electrodes, each having a conductive contact portion, and a plurality of resilient conductive terminals configured to be flexibly movable between an engaged position where they engage with the conductive electrodes and a disengaged position where they are away from the conductive electrodes. The driving card functions as a driving device for driving at least one of the resilient conductive terminals to flexibly switch its position from one of the engaged position and the disengaged position to the other. The identification switch assembly has the advantages of having a simple structure, being user friendly and being mountable to electronic devices and public facilities.

### FIELD OF THE INVENTION

The present invention relates to a switch assembly, and more particularly, to an identification switch assembly operated by virtue of varying voltage or current level.

### DESCRIPTION OF THE RELATED ART

Switches are present everywhere in our life and may highly vary depending upon applications. For example, with the advance of the technology involved in the art of illumination apparatuses, the lamp switches developed nowadays are capable of varying the brightness and hue of illuminating lamps based on the times the operators have triggered the switches. In the case of radio equipments, the channel switches in traditional radios are normally made in the form of a swivel which also functions as a power switch, whereas modern mobile phones and MP3 players with radio function are equipped with switch buttons or even touch panels that can be activated to change channels by a press or a touch. For the confidential information and valuable objects with high security demand, such as those regarding new product development, trade secrets of a business entity and personal privacy and property, identification switches are often employed at access control points, including burglary resistant safes and entrances of laboratories, business offices and private places.

On the other hand, for the public facilities that are being used frequently and have lower demand for security, control switches having simpler structures and functions are utilized to reduce general administrative expenses. As an example of these public facilities, mention may be made in a non-limiting way of a public telephone sales system for use in the business office where employees are not assigned fixed seats, public computer workstations available in an intranet system of a company's research and development department, and a card reader 91 mounted on a copy machine 9 and functioning as a switch as shown in FIG. 1. As such, a card holder is allowed access to the facilities by insertion of a magnetic card 8 which exclusively belongs to the card holder himself or his employer and is pre-stored with a certain amount of money or programmed to have a maximum number of usage within a certain period. A cost-efficient security control and management may therefore be achieved by verifying a user's credential and by limiting the maximum number of using the facilities.

However, a disadvantage to using a magnetic card 8 as an access credential is that once the magnetic card 8 is inadvertently brought in close proximity to, for example, a magnetic tape degausser installed at a grocery store or other objects that generate a strong magnetic filed, it would be placed at risk of being demagnetized. Although IC cards provided with IC chips are recently developed in place of the traditional magnetic cards, they are costly and still possibly interfered with or even destroyed by electromagnetic wave-generating facilities. Especially, in the case of dry weather, the electrostatic discharge from a human body can be as high as thousands of volts and causes damage to IC chips. Reproducing an IC card due to the reasons mentioned above is apparently cost ineffective for the public facilities that have low demand for security.

Therefore, there exists a need for an identification switch assembly for preliminarily identifying a user's credential that allows access to electronic devices or public facilities, the driving devices of which has a simple structure with high portability that allows it to be reproduced at low cost in case of misplacement or damage and is less susceptible to electromagnetic interference. Advantageously, the identification switch assembly can identify a user's credential upon varying voltage or current level. The present invention provides the best solution in response to the need.

### SUMMARY OF THE INVENTION

Accordingly, an object of the present invention is to provide an identification switch, which is less susceptible to and even not damaged by electromagnetic interference.

Another object of the invention is to provide an identification switch assembly operated in association with various driving cards.

It is still another object of the invention to provide an identification switch assembly, which ensures a certain degree of security and safety.

It is still another object of the invention to provide an identification switch assembly, which is simple in structure and suitable for being mounted on potable electronic devices and public facilities.

It is still another object of the invention to provide an identification switch assembly, which can be manufactured at low cost.

The present invention therefore provides an identification switch, comprising: a plurality of conductive electrodes, each having a conductive contact portion, the respective conductive contact portions being spaced apart from each other; a plurality of resilient conductive terminals extending in a longitudinal direction, each having a contact corresponding to one of the conductive contact portions of the conductive electrodes, the resilient conductive terminals being flexibly movable between an engaged position, where the respective contacts are electrically engaged with the corresponding conductive contact portions, and a disengaged position, where the contacts are away from the corresponding conductive contact portions; and at least one driving device configured to be movable relative to the resilient conductive terminals along a direction parallel to the longitudinal direction from a start position, where the driving device is away from the resilient conductive terminals, to a predetermined driving position, where at least one of the resilient conductive terminals is driven by the driving device to switch its position from one of the engaged position and the disengaged position to the other. For the sake of elucidation, the driving device is exemplified herein by a driving card made of plastics.

The present invention addresses the drawbacks mentioned above in an effective manner by providing an identification switch assembly which is simple in structure, has a basic identification function for ensuring security and is less susceptible to and even not damaged by electromagnetic interference.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 shows a conventional way to access a copy machine by using a card reader as a switch and a magnetic card as an access credential;

FIG. 2 is a schematic diagram of an identification switch according to the first embodiment of the invention, which is inserted with a driving card during practical use;

FIG. 3 shows an identification switch built within a microprocessor, and a driving card which has been ejected outwardly a predetermined distance by a latching/ejecting device;

FIG. 4 is a top view of the invention shown in FIG. 3;

FIG. 5 is a side view of the invention shown in FIG. 3, in which the structural parts of the invention move from their initial positions shown by the solid lines to the positions shown by phantom lines;

FIG. 6 is a perspective view of the driving card shown in FIG. 3;

FIG. 7 is a schematic cross-section diagram of the second embodiment of the invention, in which a driving card is at a start position;

FIG. 8 is a schematic diagram showing that the driving card of FIG. 7 is moved to a predetermined driving position;

FIG. 9 is a schematic diagram showing that the driving card is ejected outwardly from the predetermined driving position and resumes its initial state;

FIG. 10 is a schematic cross-section diagram showing the third embodiment of the invention, in which the identification switch is initially placed in an electrically conductive state when the driving card is at a start position; and

FIG. 11 is another schematic diagram of the third embodiment of the invention, showing that the electrically conductive path is interrupted by the driving card.

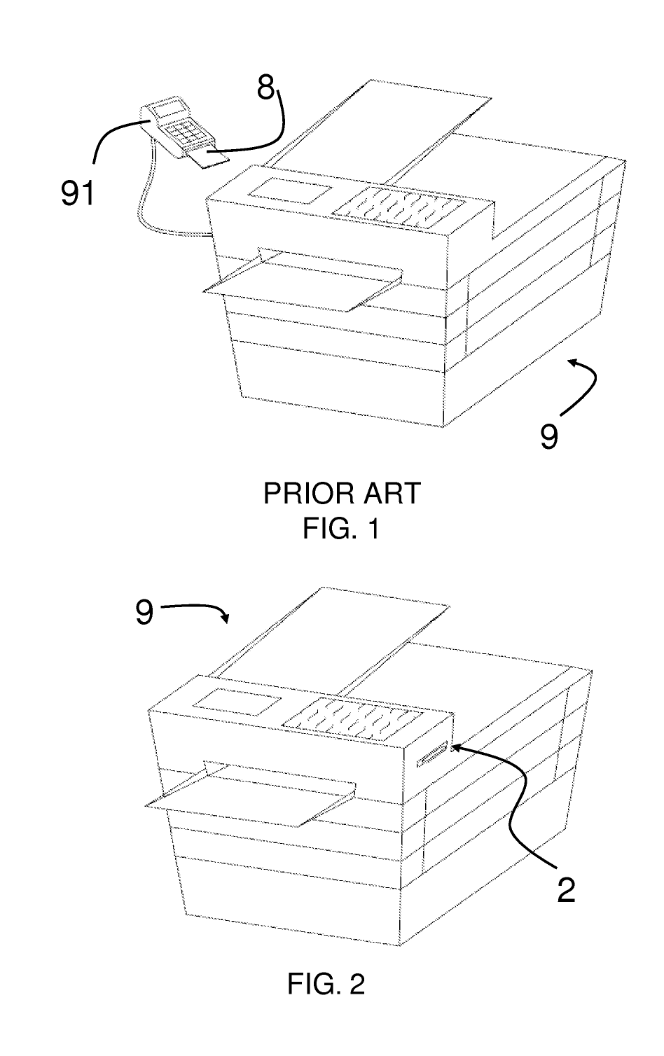

### DETAILED DESCRIPTION OF THE INVENTION

By an identification switch assembly is meant in the sense of the present invention a combination of a single switch body with a variety of driving cards for use as driving devices. For the sake of clarity, a single driving card is employed hereafter for illustration of the technical relationship between the driving devices and the switch body.

Similar to the conventional technology involving magnetic cards and card reader as described above, the identification switch 2 shown in FIG. 2 are associated with a microprocessor (not shown) for receiving a voltage or current signal generated by insertion of a driving card into the switch body, thereby initiating the copy machine 9 while recording the number of usage for statistic use.

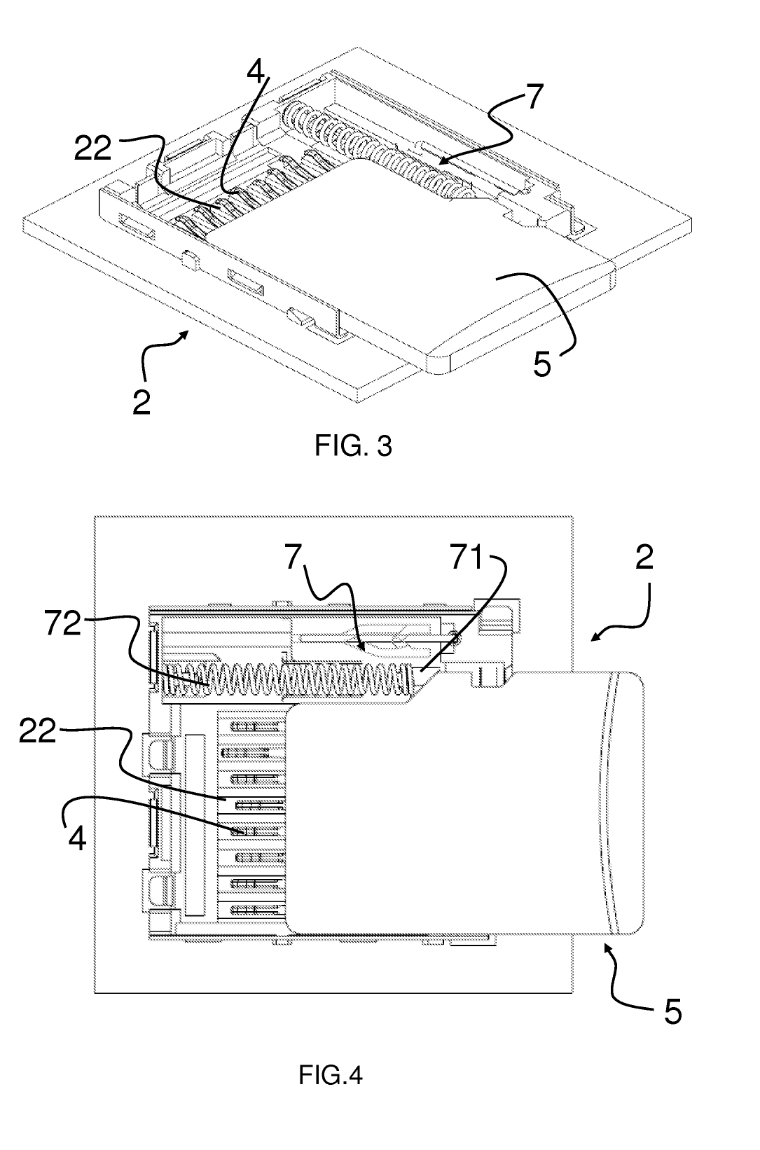

As shown in FIGS. 3-5, an identification switch 2 has a plurality of conductive electrodes 22, a plurality of resilient conductive terminals 4, a driving card 5 and a latching/ejecting device 7. According to this embodiment, the identification switch 2 may by way of example be configured to be an 8-bit operating system, in which eight conductive electrodes 22 are housed in a switch body (not designated). For the sake of elucidation, the part of a conductive electrode necessary for the electrical connection is designated as a conductive contact portion 221. The respective conductive contact portions 221 are spaced apart from each other. A plurality of resilient conductive terminals 4 are mounted correspondingly to the conductive electrodes 22 and extend in a longitudinal direction. A contact 421 is defined to be the part of a resilient conductive terminal 4 for engagement with a conductive contact portion 221 of a corresponding conductive electrode 22. The latching/ejecting device 7 has a push rod 71 and an elastic member 72 for driving the push rod 71.

In this embodiment, the driving card 5 is an integrally formed plastic plate having a body 51 and a driving teeth part 52 extending from the body 51, as shown in FIG. 6. The driving teeth part 52 is divided into eight binary components corresponding to the conductive electrodes 22 and the resilient conductive terminals 4. In order to distinguish the initial state where there is no driving card inserted into the switch body, the driving card 5 is provided with at least one tapered tooth 521 which has a slant slide surface 522 corresponding to a resilient conductive terminal 4.

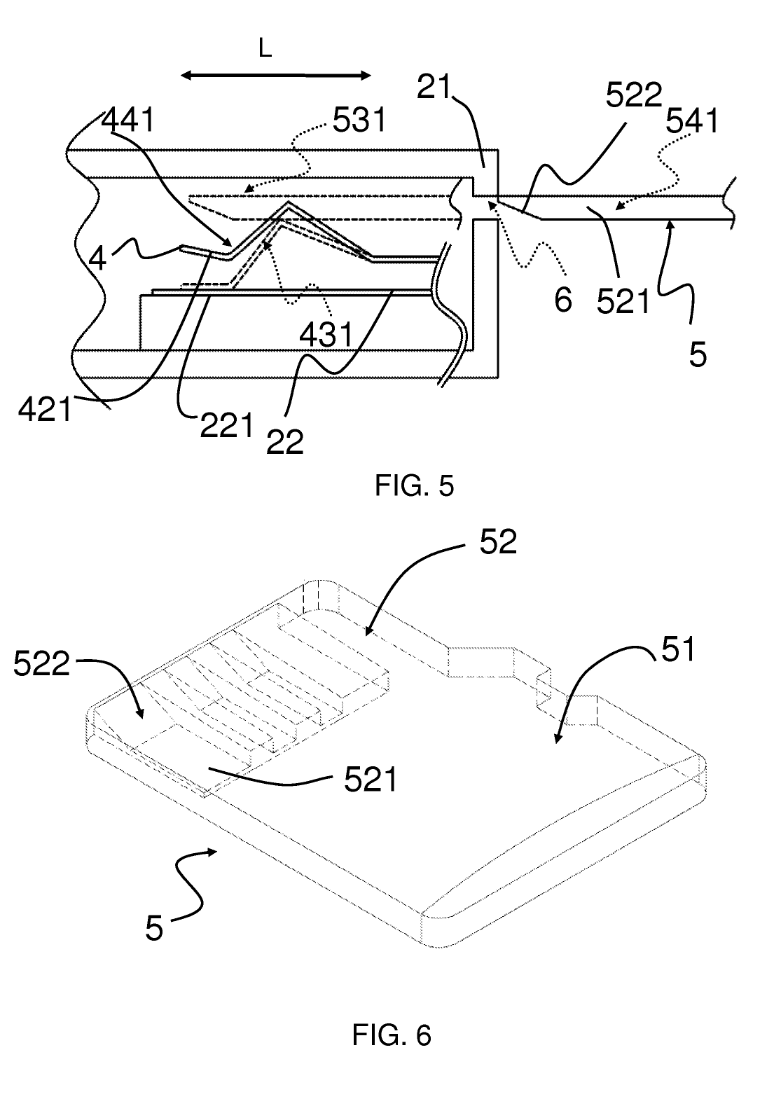

When the driving card 5 is placed at a start position 541 outside of the dielectric housing 21 and then inserted into the switch body via an insert slot 6 as shown by the phantom lines in FIG. 5, the resilient conductive terminal 4 that faces the corresponding tapered tooth 521 is forced by the advancing slant slide surface 522 to gradually and resiliently deform from a disengaged position 441, where the conductive terminal 4 is away from the conductive contact portion 221 of the corresponding conductive electrode 22, toward the conductive electrode 22, until the driving card 5 reaches a predetermined driving position 531 in the switch body as shown by the phantom lines in FIG. 5, and is held over there by the latching/ejecting device 7. At this moment, the contact 421 of the resilient conductive terminal 4 arrives at an engaged position 431, where the contact 421 is brought in contact with the corresponding conductive contact portion 221, in response to the abutment of the tapered tooth 521. According to this embodiment, if the latched driving card 5 is subsequently pushed inwardly, the push rod 71 will release the driving card 5 to allow the elastic member 72 to eject the driving card 5 from the predetermined driving position 531, whereby the resilient conductive terminal 4 returns back to the disengaged position 441.

Of course, it would be appreciated by those skilled in the art that the embodiment described above, in which the driving card 5 is made of a homogeneous non-magnetic material and the latching/ejecting device 7 is preferably configured as described, is provided for illustrative purpose only and is not intended to limit the scope of the invention. Furthermore, the embodiment above is operated by virtue of the 256 permutations of electrical conduction patterns created from eight conductive electrode-resilient conductive terminal pairs, each pair either constituting an electrically conductive path or not when the driving card is held at the predetermined driving position. Exclusive of the initial state where none of the eight pairs forms an electrically conductive path, there still remain 255 permutations for making the identification system. Needless to say, a number of electrodes and terminals can be added or omitted during actual use of the invention.

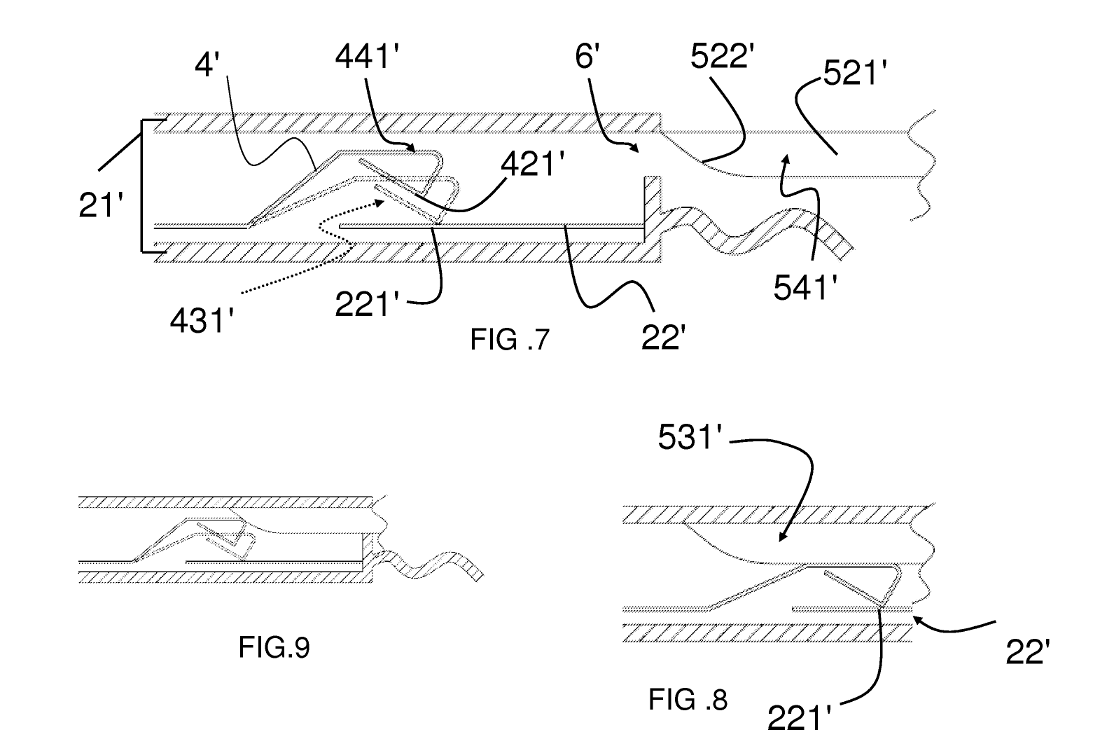

The profiles of the conductive electrodes, resilient conductive terminals and driving card, their locations relative to the switch body, and the location of the slot in the identification switch for receiving and ejecting the driving card may also be variable. As shown in FIG. 7, a plurality of resilient conductive terminals 4′, each having a P-shaped front end with respect to a conductive electrode 22′ mounted downside, extend toward an insert slot 6′ formed on a dielectric housing 21′. A driving card is movable relative to the resilient conductive terminals 4′ from a start position 541′ along a direction parallel to the longitudinal direction. At least one tapered tooth 521′ protrudes from the driving card toward the insert slot 6′ and has an arc-shaped slant slide surface 522′ at front edge. The resilient conductive terminals 4′ are initially set to settle at a disengaged position 441′ where the contacts 421′ are away from the conductive contact portions 221′, rather than at an engaged position 431′ as indicated by the phantom line. When the tapered tooth 521′ reaches a predetermined driving position 531′ as shown in FIG. 8, the contact 421′ of the resilient conductive terminal 4′ is rendered to engage the conductive contact portion 221′ of the conductive electrode 22′, whereby an electrically conductive path is formed between them.

FIG. 9 shows that a latching/ejecting device is actuated to eject the driving card toward the start position until the driving card reaches a predetermined distance away from the predetermined driving position. This does not only give a user convenient access to the driving card, but also allows the resilient conductive terminals biased to the engaged position to return back to the disengaged position.

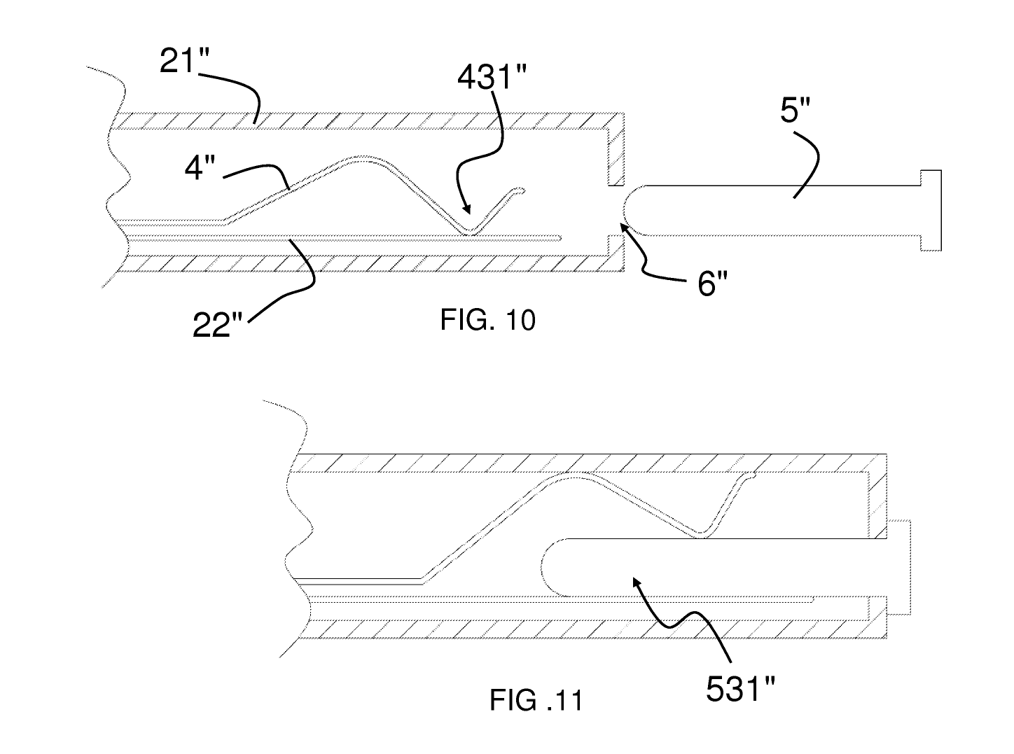

According to the third embodiment of the invention shown in FIGS. 10 and 11, a resilient conductive terminal 4″ is configured to initially reside at an engaged position 431″ within a dielectric housing 21″ and engage with a conductive electrode 22″, such that the identification switch is initially placed in an electrically conductive state. A driving card 5″ is provided to have a semicircular curved surface at its front edge and is movable to pass through an insert slot 6″ formed on the dielectric housing 21″ along a longitudinal direction in which the resilient conductive terminal 4″ extends. As it reaches a predetermined driving position 531″, the resilient conductive terminal 4″ is separated from the conductive electrode 22″ and the electrically conductive path is interrupted.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. An identification switch, comprising:
a plurality of conductive electrodes, each having a conductive contact portion, the respective conductive contact portions being spaced apart from each other;
a plurality of resilient conductive terminals extending in a longitudinal direction, each having a contact corresponding to one of the conductive contact portions of the conductive electrodes, the resilient conductive terminals being flexibly movable between an engaged position, where the respective contacts are electrically engaged with the corresponding conductive contact portions, and a disengaged position, where the contacts are away from the corresponding conductive contact portions; and
at least one driving device configured to be movable relative to the resilient conductive terminals along a direction parallel to the longitudinal direction from a start position, where the driving device is away from the resilient conductive terminals, to a predetermined driving position, where at least one of the resilient conductive terminals is driven by the driving device to switch its position from one of the engaged position and the disengaged position to the other.

2. The identification switch according to claim 1, wherein the driving device is a homogenous, non-conductive and non-magnetic driving card.

3. The identification switch according to claim 2, wherein the driving card comprises a body and a driving teeth part extending from the body.

4. The identification switch according to claim 3, wherein the driving card is an integrally formed plastic plate, and wherein the driving teeth part comprises at least one tapered tooth having a slant slide surface and formed correspondingly to at least one of the resilient conductive terminals.

5. The identification switch according to claim 1, further comprising a dielectric housing for accommodating at least part of the resilient conductive terminals.

6. The identification switch according to claim 5, wherein the dielectric housing is formed with an insert slot for receiving the driving device, the insert slot being oriented at an angle with respect to the longitudinal direction.

7. The identification switch according to claim 6, further comprising a latching/ejecting device for holding the driving device at the predetermined driving position as the driving device reaches the predetermined driving position, and for moving the driving device toward the start position until the driving device reaches at least a predetermined distance away from the predetermined driving position when the driving device held at the predetermined driving position is subsequently pushed inwardly.

8. The identification switch according to claim 7, wherein the latching/ejecting device comprises a push rod and an elastic member for driving the push rod.

9. An identification switch assembly, comprising:
a plurality of conductive electrodes, each having a conductive contact portion, the respective conductive contact portions being spaced apart from each other;
a plurality of resilient conductive terminals extending in a longitudinal direction, each having a contact corresponding to one of the conductive contact portions of the conductive electrodes, the resilient conductive terminals being flexibly movable between an engaged position, where the respective contacts are electrically engaged with the corresponding conductive contact portions, and a disengaged position, where the contacts are away from the corresponding conductive contact portions; and
a plurality of driving cards configured to be movable relative to the resilient conductive terminals along a direction parallel to the longitudinal direction from a start position, where the driving device is away from the resilient conductive terminals, to a predetermined driving position, where at least one of the resilient conductive terminals is driven by the driving device to switch its position from one of the engaged position and the disengaged position to the other, each of the driving cards comprising a body and a driving teeth part extending from the body;
wherein the driving cards are distinct from each other in shapes of the driving teeth parts.

10. The identification switch assembly according to claim 9, further comprising a latching/ejecting device for holding the driving device at the predetermined driving position as the driving device reaches the predetermined driving position, and for moving the driving device toward the start position until the driving device reaches at least a predetermined distance away from the predetermined driving position when the driving device held at the predetermined driving position is subsequently pushed inwardly, and wherein the latching/ejecting device comprises a push rod and an elastic member for driving the push rod.
